(19) United States
(12) Patent Application Publication
(10) Pub. No.: US 2021/0292030 A1
(43) Pub. Date: Sep. 23, 2021

(54) BAG MANAGEMENT RACK

(71) Applicant: Christopher S. Shelton, Oxford, MS (US)

(72) Inventor: Christopher S. Shelton, Oxford, MS (US)

(21) Appl. No.: 17/264,272

(22) PCT Filed: Aug. 1, 2019
(86) PCT No.: PCT/US2019/044757

§ 371 Date: Jan. 28, 2021

Related U.S. Application Data
(60) Provisional application No. 62/713,426, filed on Aug. 1, 2018.

(51) Int. Cl. B65B 67/12; B60R 7/08

(52) U.S. Cl. CPC B65B 67/1266; B60R 7/08

(57) ABSTRACT

A bag management rack, comprises (1) a top support, (2) a bottom support, spaced apart from the top support, (3) a spacer, connecting the top support and the bottom support, (4) a first top prong and a second top prong, attached to the top support and spaced apart from each other, and (5) a first bottom prong and a second bottom prong, attached to the bottom support and spaced apart from each other. The distance between the first and second bottom prongs is less than the distance between the first and second top prongs. Furthermore, the first and second bottom prongs are aligned below and between the first and second top prongs.

### BACKGROUND

Package courier companies, such as UPS, use reusable bags to transport packages. These bags typically include a pair of holes near the bag opening, which may be reinforced with grommets. After use, but before reuse, the bags tend to collect. If not organized and stored, they can collect within the truck used to transport the packages or in facilities which handle the packages, where they can interfere with movement of equipment or personnel and may also become a slip hazard. Workers who handle the bags are typically required to organize and store the bags. In some instances, a set of bags, for example 9 bags, may be stored within a tenth bag. Because the bags are all the same size, it can take some time to inset the set of bags into the storage bag. It is not unusual for workers who handle packages and bags to spend as much as one hour of each work day organizing and storing bags.

### SUMMARY

In a first aspect, the present invention is a bag management rack, comprising (1) a top support, (2) a bottom support, spaced apart from the top support, (3) a spacer, connecting the top support and the bottom support, (4) a first top prong and a second top prong, attached to the top support and spaced apart from each other, and (5) a first bottom prong and a second bottom prong, attached to the bottom support and spaced apart from each other. The distance between the first and second bottom prongs is less than the distance between the first and second top prongs, and the first and second bottom prongs are aligned below and between the first and second top prongs.

In a second aspect, the present invention is a bag management rack, comprising (i) a frame, (ii) a first top prong and a second top prong, attached to the frame and spaced apart from each other, and (iii) a first bottom prong and a second bottom prong, attached to the frame and spaced apart from each other. The distance between the first and second bottom prongs is less than the distance between the first and second top prongs, and the first and second bottom prongs are aligned below and between the first and second top prongs.

In a third aspect, the present invention is a method of bundling bags, the bags having first and second holes near an opening of each bag, the method comprising attached a plurality of bag to a bag management rack, by placing the first and second holes of each bag onto the first and second top prongs, respectively, causing the plurality bags to hang from the bag management rack and causing the bottom of the plurality of bags to crimp between the first and second bottom prongs; then sliding the plurality of bags into a final bag simultaneously, by first inserting the bottom of the plurality of bags into the final bag, and finally pulling the plurality of bags off the bag management rack.

### BRIEF DESCRIPTION OF THE DRAWINGS

FIG. 1A illustrates a bag management rack in an open position.

FIG. 1B illustrates a bag management rack in a closed position.

FIG. 2 is an image showing a bag management rack.

FIG. 3 is an image showing a bag management rack holding several bags.

FIG. 4, FIG. 5, FIG. 6, FIG. 7 and FIG. 8 are a series of images illustrating the steps of using the bag management rack to organize 9 bags into a tenth bag.

### DETAILED DESCRIPTION

The present invention makes use of a bag management rack which allows for the convenient holding of bags while they are not in use, to prevent the bags from interfering with movement of equipment or personnel, or from becoming a slip hazard. Furthermore, the bag management rack allows for the easy and quick collection of a set of bags and then the insertion of the set of bags into a further bag. Use of the bag management rack to collect and organize bags can significantly reduce the amount of time workers spend collecting and organizing the bags.

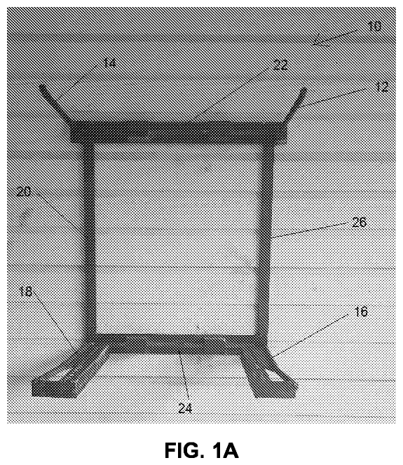

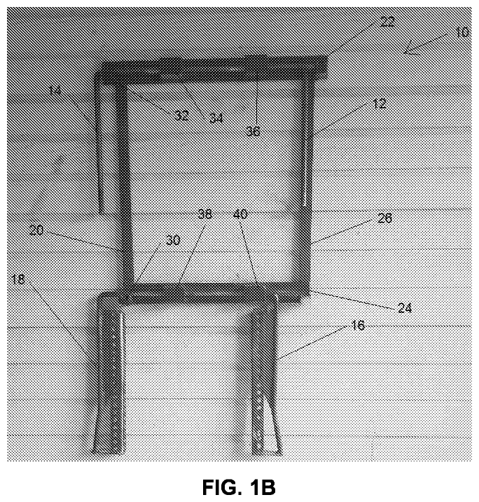

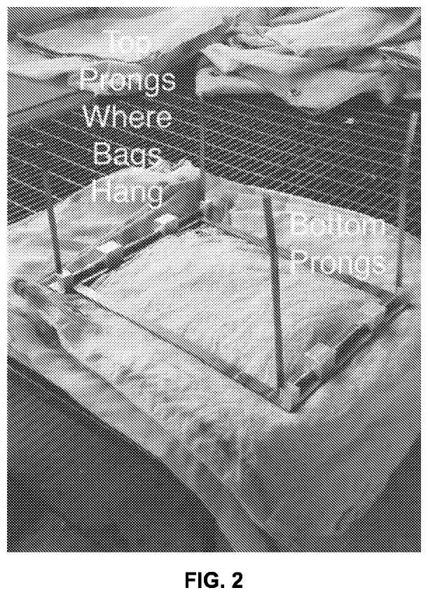

FIG. 1A illustrates a bag management rack, 10, in an open position. In the open position the bag management rack may be used to collect bags and insert a set of bags into a bag. The bag management rack includes a first top prong, 12, and a second top prong, 14, for receiving the holes of the bags. The bag management rack also includes a first bottom prong, 16, and a second bottom prong, 18, for crimping the bottom of the bags after they are hung on the top prongs. A frame holds the prongs and maintains the distance between them, which includes a top support, 22, a bottom support, 24, and a spacer which includes a first side support, 20, and an optional second side support, 26.

The top prongs may be made as long as desired in order to hold the number of bags desired. For example, to hold 9 bags, the top prongs may be at least 14 inches long. For ease of handling, the top prongs should not be made longer than 28 inches. Other lengths in the range of 10 to 30 inches are possible, including 11, 12, 13, 14, 15, 16, 17, 18, 19, 20, 21, 22, 23, 24, 25, 26, 27, 28 and 29 inches. The top prongs are spaced a distance apart suitable for conveniently holding the bags, and that distance is determined by the size of the bags, and the location of the holes in the bags. Preferably, the top prongs are spaced 12 to 36 inches apart, including 14, 16, 18, 20, 22, 24, 26, 28, 30, 32 or 34 inches.

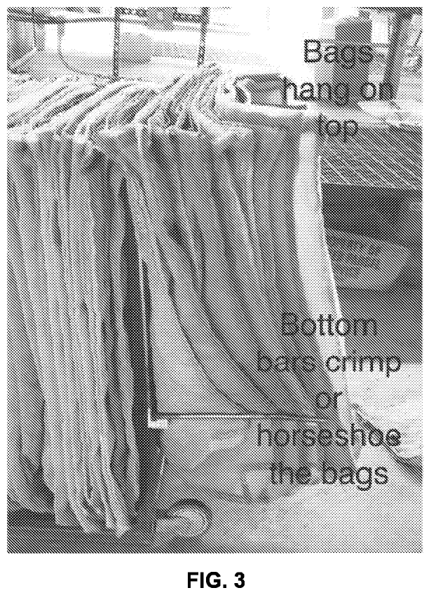

The bottom prongs are an important feature which allows for crimping the bottom of the bags, and greatly eases and reduces the time needed for insertion of a set of bags into a further bag. The bottom prongs must have a distance between each other which is less than the width of the bags, and preferably less than the distance between the top prongs, so that the bags will crimp when hung on the top prongs, preferably 1, 2, 3, 4, 5, 6, 7, 8, 9 or 10 inches closer together than the top prongs. For example, the bottom prongs may be spaced 8 to 36 inches apart, including 9, 10, 11, 12, 13, 14, 16, 18, 20, 22, 24, 26, 28, 30, 32 or 34 inches. The bottom prongs are preferably longer than the top prongs, for example 1, 2, 3 or 4 inches longer, but this is not required. The bottom prongs may be 10 to 34 inches long, including 11, 12, 13, 14, 15, 16, 17, 18, 19, 20, 21, 22, 23, 24, 25, 26, 27, 28, 29, 30, 31, 32, 33 and 34 inches. The crimping of the bags is shown in FIG. 3. The number of bags organized into a single bag may be a set of 2, 3, 4, 5, 6, 7, 8, 9, 10, 11, 12, 13, 14, 15 or even 16 bags.

The top prongs are shaped to accept the bags by hanging them through the holds onto the top prongs. Preferably the top prongs have a circular or square cross-section. The shape of the bottom prongs is not restricted, nor is the thickness of the bottom prongs. For example, the bottom prongs may have a circular or square cross-section, or could be flat.

The top and/or the bottom prongs may be curved up at the ends. Alternatively, the top and/or bottom prongs may be angled upwards rather than extending straight out from the frame. The frame, and therefore the top support, the bottom support, and the side supports, are sized to hold the top and bottom prongs is the desired arrangement. The distance between the top prongs and the bottom prongs should be shorter than the bags, so the bottom of the bags is crimped. For example, the distance between the top prongs and the bottom prongs may be 12, 13, 14, 15, 16, 17, 18, 19, 20, 21, 22, 23, 24, 25 or 26 inches.

The purpose of the bag management rack is to bundle the bags in an organized and efficient manner instead of letting them fall loosely to the floor after they have been emptied. The rack may be bolted, hung or built on a stand (as shown in FIG. 3), or may be hung on a wall or inside a trailer of a truck. The bag management rack could also be hung with S-hooks or have E-track fittings welded onto the actual rack and fit into the E-track that runs down the side of most truck trailers. If hung from a hook or an E-track, then a block would need to be added to the bottom corner of each side of the rack to make the rack flush from top to bottom.

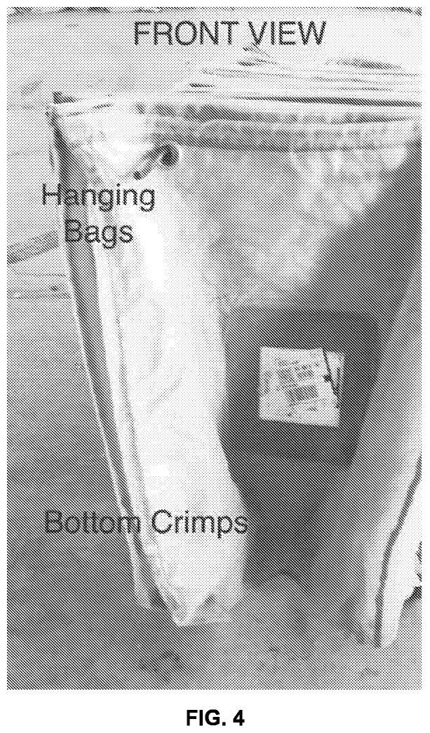

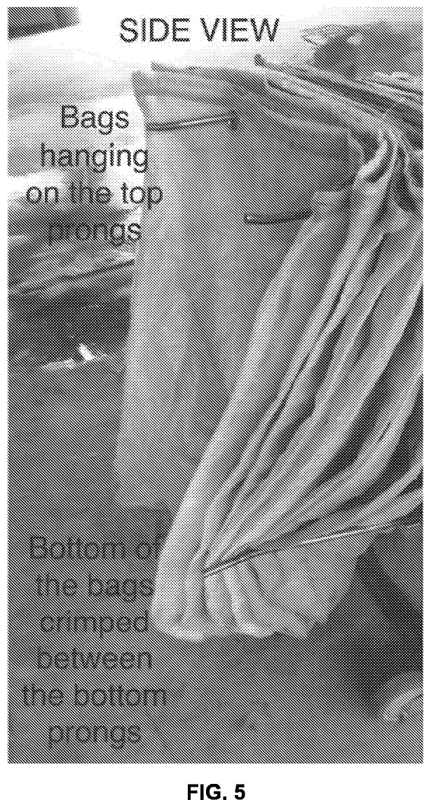

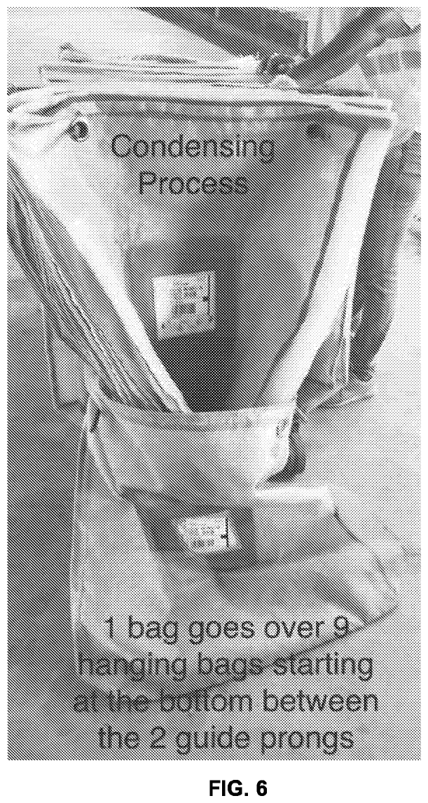

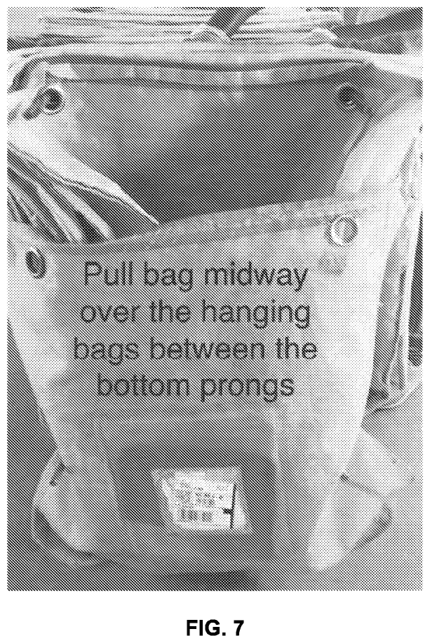

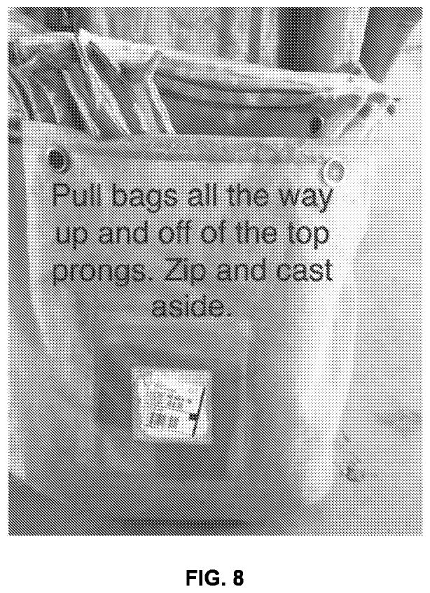

FIGS. 4-8 are a series of images illustrating the steps of using the bag management rack to organize 9 bags into a tenth bag. The following describes an example of steps for organizing the bags:

Step 1: Slide a bag onto the top prongs.

Step 2: Push the bottom part of the bag between the two bottom prongs with hands or feet.

Step 3: Repeat Steps 1 and 2 until the rack is filled with bags.

Step 4: Slide a further bag around the bottom of the bags on the rack.

Step 5: Pull the further bag up around the bags on the rack.

Step 6: Pull the bagged bags off the top prongs.

FIG. 1B illustrates a bag management rack, 10, in a closed position. Further illustrated are top prong support, 32, bottom prong support, 30, as well as top prong hinges, 34 and 36, and bottom prong hinges, 38 and 40. In the illustration, the top prongs and the bottom prongs are each attached to a circular cross-section bar. In use, the bars are rotated so that the top prongs and bottom prongs extend away from the rack, and one or both of the top prongs, and one or both of the bottom prongs, rest on the top prong support and bottom prong support, respectively. In an alternative embodiment, the prongs are not attached to the same circular cross-section bar, and each prong would have a corresponding prong support, allowing each prong to be extended or closed separately.

1-12. (canceled)

13. A method of bundling bags, the bags having first and second holes near an opening of each bag, with a bag management rack comprising:
(1) a top support,
(2) a bottom support, spaced apart from the top support,
(3) a spacer, connecting the top support and the bottom support,
(4) a first top prong and a second top prong, attached to the top support and spaced apart from each other, and
(5) a first bottom prong and a second bottom prong, attached to the bottom support and spaced apart from each other,
wherein the distance between the first and second bottom prongs is less than the distance between the first and second top prongs, and
the first and second bottom prongs are aligned below and between the first and second top prongs,
the method comprising:
attached a plurality of bag to the bag management rack of claim 1, by placing the first and second holes of each bag onto the first and second top prongs, respectively, causing the plurality bags to hang from the bag management rack and causing the bottom of the plurality of bags to crimp between the first and second bottom prongs,
sliding the plurality of bags into a final bag simultaneously, by first inserting the bottom of the plurality of bags into the final bag, and
pulling the plurality of bags off the bag management rack.

14. The method of claim 13, wherein the plurality of bags is 2 to 16 bags.

15. The method of claim 13, wherein the plurality of bags is 8 to 10 bags.

16. The method of claim 13, wherein:
the top prongs have a length of 10 to 30 inches,
the bottom prongs have a length of 10 to 34 inches,
the top prongs are spaced apart 12 to 36 inches, and the bottom prongs are spaced apart 8 to 36 inches.

17. The method of claim 13, further comprising prior to the attaching, arranging the bag management rack for a closed position to an open position.

18. The method of claim 13, wherein the bag management rack is attached to a stand.

19. The method of claim 13, wherein the bag management rack is attached to a truck trailer.

20. A method of bundling bags, the bags having first and second holes near an opening of each bag, with a bag management rack comprising:
(i) a frame,
(ii) a first top prong and a second top prong, attached to the frame and spaced apart from each other, and
(iii) a first bottom prong and a second bottom prong, attached to the frame and spaced apart from each other,
wherein the distance between the first and second bottom prongs is less than the distance between the first and second top prongs, and
the first and second bottom prongs are aligned below and between the first and second top prongs,
the method comprising:
attached a plurality of bag to the bag management rack by placing the first and second holes of each bag onto the first and second top prongs, respectively, causing the plurality bags to hang from the bag management rack and causing the bottom of the plurality of bags to crimp between the first and second bottom prongs,
sliding the plurality of bags into a final bag simultaneously, by first inserting the bottom of the plurality of bags into the final bag, and
pulling the plurality of bags off the bag management rack.
